(19) United States
(12) Patent Application Publication
(10) Pub. No.: US 2019/0264704 A1
(43) Pub. Date: Aug. 29, 2019

(54) IMPELLER FOR A RADIAL FAN AND GAS BURNER APPLIANCE

(71) Applicant: Honeywell Technologies Sarl, Rolle (CH)

(72) Inventors: Kay Jarysek, Georgsmarienhuette (DE); Gerrit Wascher, Lotte (DE)

(21) Appl. No.: 16/285,059

(22) Filed: Feb. 25, 2019

(30) Foreign Application Priority Data
Feb. 26, 2018 (EP) 18158633.0

(51) Int. Cl. F04D 29/42; F23D 14/28; F23D 14/70

(52) U.S. Cl. CPC F04D 29/4226; F23D 14/28; F23N 2033/06; F05D 2270/30; F23D 14/70

(57) ABSTRACT

Impeller for a radial fan, the impeller comprising a front side, a rear side and a peripheral edge, a hub element, an annular covering disc positioned on the front side, an intake opening formed on the front side, a support disc positioned on the rear side, blades extending substantially radially from the hub element towards the peripheral edge, and outflow openings formed in the region of the peripheral edge. A first outer diameter of a radially outer edge of the annular covering disc is greater than a second outer diameter of a radially outer edge of the support disc. Openings are formed in the annular covering disc, wherein the openings are positioned between the radially outer edge of the annular covering disc having the first outer diameter and a radially inner edge of the annular covering disc having a first inside diameter.

The present application relates to an impeller for a radial fan and to a gas burner appliance having a radial fan.

DE 20 2004 012 015 U1 discloses an impeller for a radial fan. This impeller comprises a front side, a rear side and a peripheral edge. This impeller further comprises a hub element and an annular covering disc positioned on the front side. An intake opening is formed on the front side. Outflow openings are formed in the region of to the peripheral edge. Blades extend substantially radially from the hub element to the peripheral edge. An outer diameter of a radially outer edge of the annular covering disc defines the maximum outside-diameter of the impeller.

EP 2 196 679 A2 discloses another impeller for a radial fan. The impeller disclosed by EP 2 196 679 A2 comprises a front side, a rear side and a peripheral edge. This impeller further comprises a hub element, an annular covering disc positioned on the front side and a support disc positioned on the rear side. An intake opening is formed on the front side. Outflow openings are formed in the region of the peripheral edge. Blades extend substantially radially from the hub element to the peripheral edge. An outer diameter of a radially outer edge of the support disc defines the maximum outside-diameter of the impeller. An outer diameter of a radially outer edge of the annular covering disc is smaller than the outer diameter of a radially outer edge of the support disc. Such an impeller is also disclosed by US 2004/0247441 A1.

U.S. Pat. No. 3,479,017 A discloses another impeller according to the prior art.

Against this background, a novel impeller for a radial fan is provided.

The impeller according to the present application is defined in the claim 1.

According to the present application, a first outer diameter of a radially outer edge of the annular covering disc is greater than a second outer diameter of a radially outer edge of the support disc. According to the present application, openings are formed in the annular covering disc, wherein the openings are positioned between the radially outer edge of the annular covering disc having the first outer diameter and a radially inner edge of the annular covering disc having a first inside diameter. Such an impeller can be manufactured as one monolithic piece while providing a good performance with a high efficiency and low noise during operation.

Preferably, the peripheral edge and thereby a maximum outside-diameter of the impeller is defined by the first outer diameter of the radially outer edge of the annular covering disc. Such an impeller can be manufactured as one monolithic piece while providing a high efficiency and low noise during operation of the same. Alternatively, the blades may protrude radially outwardly from the radially outer edge of the annular covering disc. In this case, the peripheral edge and thereby a maximum outside-diameter of the impeller is defined by an outer diameter of the blades.

The ratio A2/A1 between an axially effective surface area A2 of the support disc and an axially effective surface area of the annular covering disc may be in a range between 0.5 and 0.9. Preferably, the ratio A2/A1 is in a range between 0.6 and 0.8. Most preferred, the ratio A2/A1 is in a range between 0.65 and 0.75. Such a ratio A2/A1 is preferred to maximize efficiency of the impeller and to minimize noise of the impeller during operation of the same.

The openings formed within the annular covering disc are conically shaped, namely in such a way that the openings formed within the annular covering disc taper in axial direction towards the support disc. These details are preferred to provide an impeller that can be easily and reliably manufactured as one monolithic piece.

The gas burner appliance according to the present application is defined in the claim 15.

Preferred developments of the invention are provided by the dependent claims and the description which follows. Exemplary embodiments are explained in more detail on the basis of the drawing, in which:

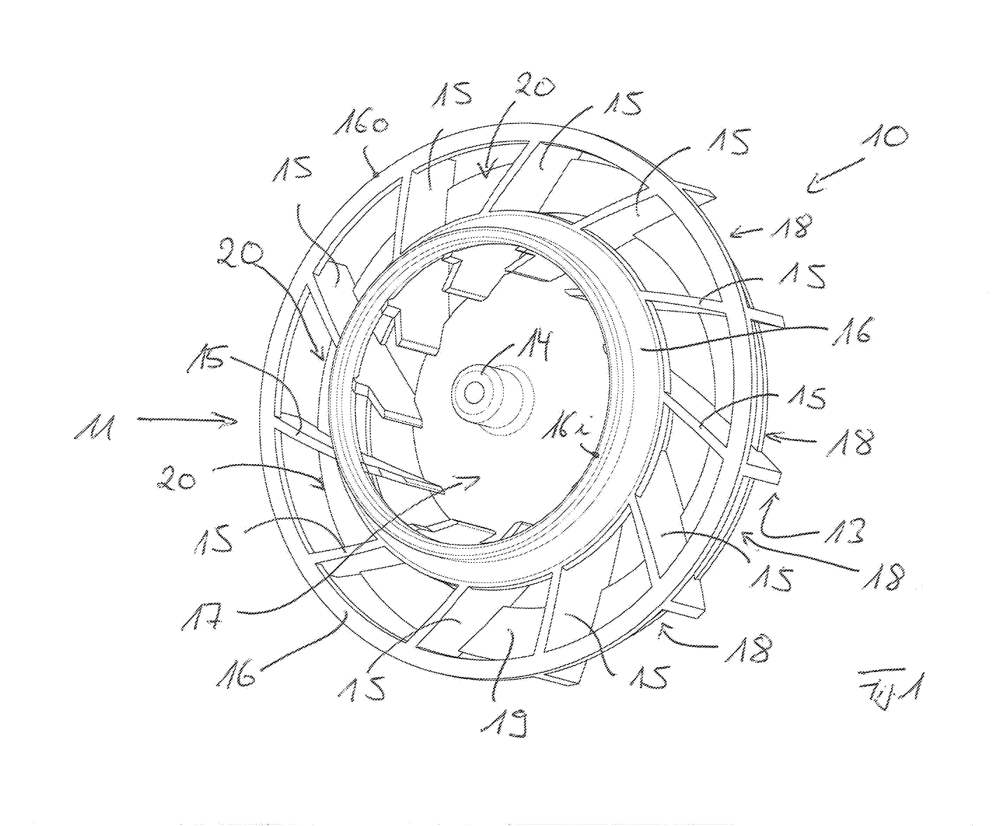

FIG. 1 shows a perspective view on a front side of an impeller for a radial fan according to the present application;

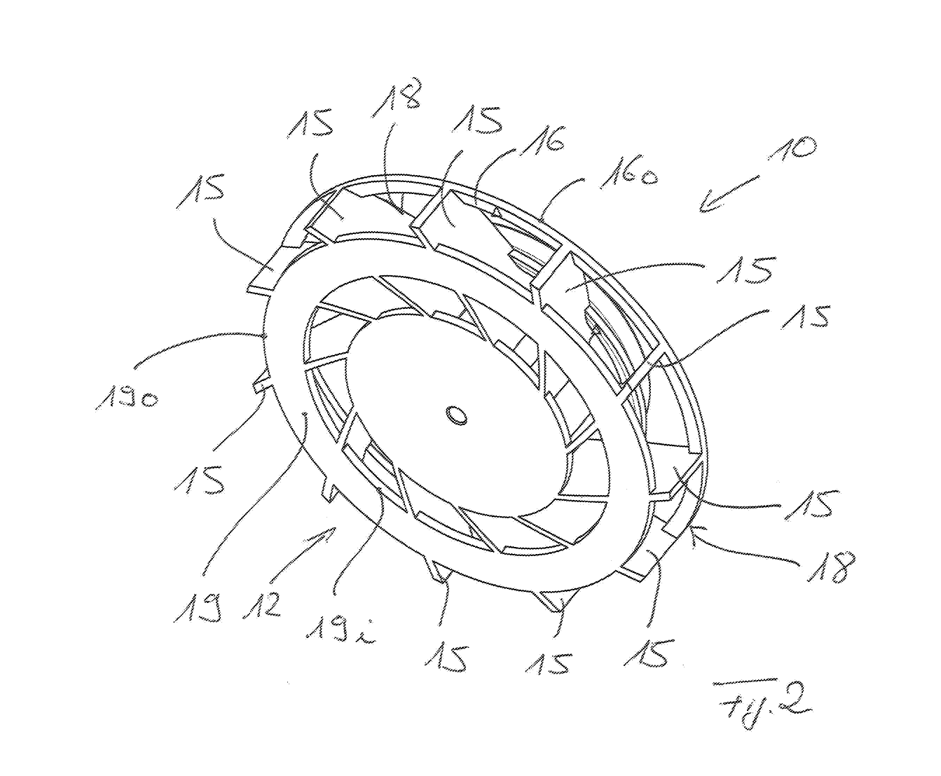

FIG. 2 shows a perspective view on a rear side of the impeller of FIG. 1;

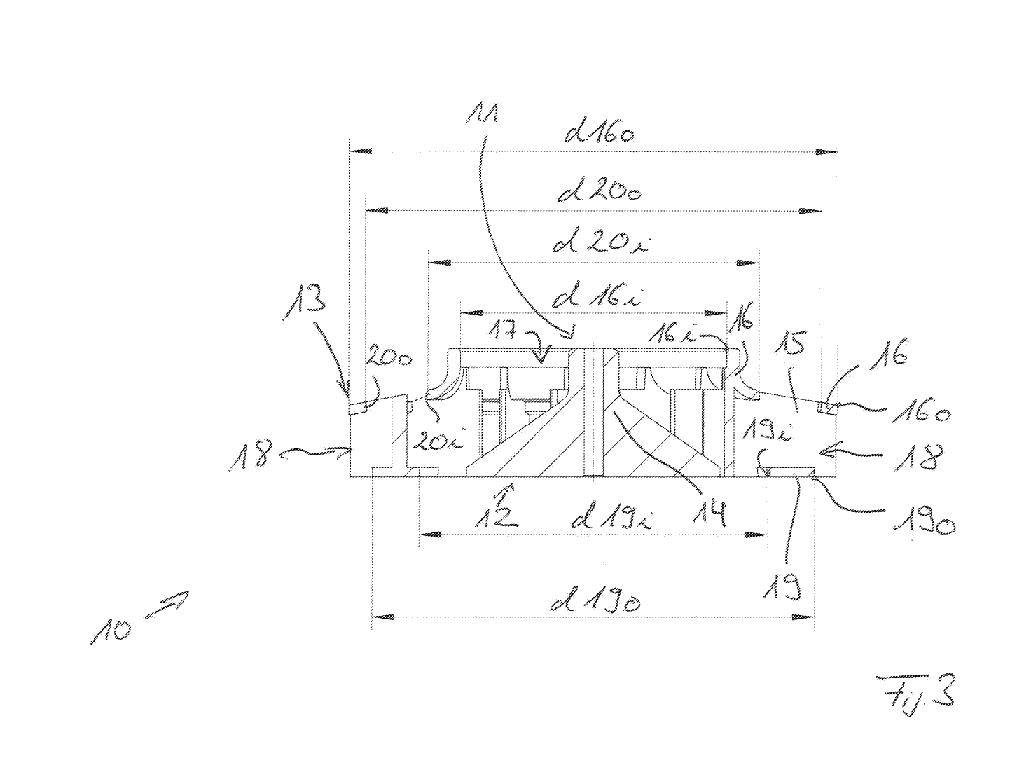

FIG. 3 shows a cross section through the impeller of FIGS. 1 and 2 showing geometrical parameters of the same;

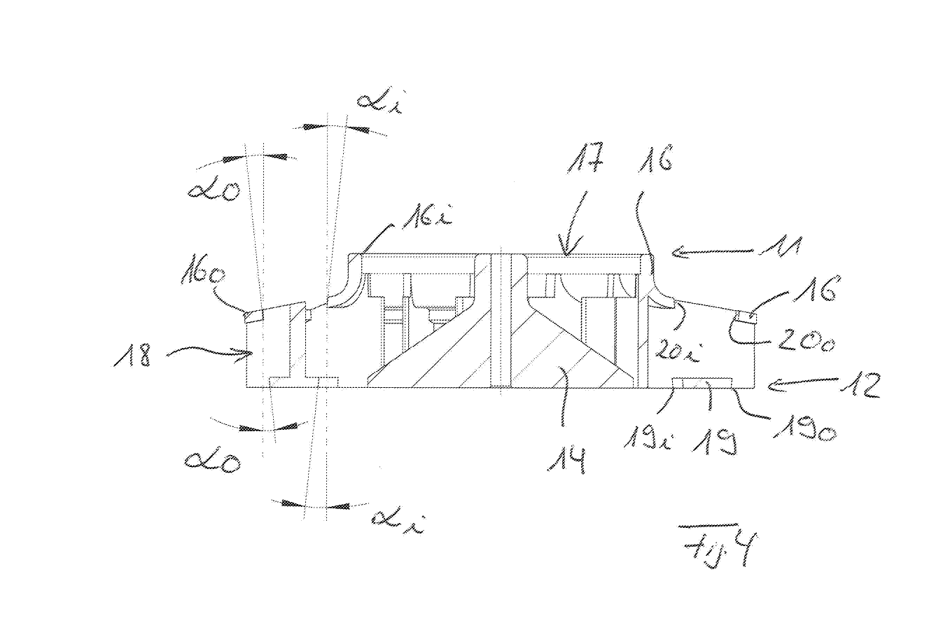

FIG. 4 shows the cross section of FIG. 3 with other geometrical parameters of the same.

The present application relates to an impeller for a radial fan. FIGS. 1 to 4 show different views of an impeller 10 according to the present application.

The impeller 10 comprises a front side 11, a rear side 12 and a peripheral edge 13. The impeller 10 comprises a hub element 14. The impeller 10 can be coupled to a shaft of a motor through said hub element 14. The impeller 10 comprises blades 15 extending substantially radially from the hub element 14 to the peripheral edge 13.

The impeller 10 comprises an annular covering disc 16 positioned on the front side 11. An intake opening 17 of the impeller 10 is formed on the front side 11.

Outflow openings 18 are formed in the region of to the peripheral edge 13. Between each two adjacent blades 15 there is defined one outflow opening 18.

A fluid like air or a gas/air mixture can be supplied by the impeller 10. The fluid flows through the intake opening 17 along the blades 15 towards the outflow openings 18.

The impeller 10 comprises a support disc 19 positioned on the rear side 12.

The annular covering disc 16 has a radially inner edge 16i with a first inside diameter d16i and a radially inner edge 16o with a first outer diameter d16o. The radially inner edge 16i of the annular covering disc 16 defines the intake opening 17 on the front side 11 of the impeller 10.

The support disc 19 has a radially inner edge 19i with a second inside diameter d19i and a radially outer edge 19o with a second outer diameter d19o.

According to the present invention, the first outer diameter d16o of the radially outer edge 16o of the annular covering disc 16 is greater the second outer diameter d19o of a radially outer edge 19o of the support disc 19.

According to the present invention, openings 20 are formed in the annular covering disc 16. The openings 20 are positioned between the radially outer edge 16o of the annular covering disc 16 having the first outer diameter d16o and a radially inner edge 16i of the annular covering disc 16 having the first inside diameter d16i. The first internal diameter d16i of the radially inner edge 16i of the annular covering disc 16 is smaller than a second internal diameter d19i of a radially inner edge 19i of the support disc 19.

Preferably, the peripheral edge 13 and thereby a maximum outer diameter of the impeller 10 is defined by the first outer diameter d16o of the radially outer edge 16o of the annular covering disc 16.

Alternatively, the blades 15 may protrude radially outwardly from the radially outer edge 16o of the annular covering disc 16. In this case, the peripheral edge 13 thereby a maximum outside-diameter of the impeller would be defined by an outer diameter of the blades 15.

The openings 20 formed within the annular covering disc 16 are defined by a radially inner edge 20i having a third internal diameter d20i and by a radially outer edge 20o having a third outer diameter d20o. The openings 20 are separated from each other by the blades 15. The third internal diameter d20i of the openings 20 is smaller than the second internal diameter d19i of the support disk 19. The third outer diameter d20o of the openings 20 is greater than the second internal diameter d19o of the support disk 19.

Such an impeller 10 can be manufactured as one monolithic piece while providing a high efficiency and low noise during operation of the same.

The annular covering disc 16 has an axially effective surface area A1. The support disc has an axially effective surface area A2. These axially effective surfaces A1, A2 can also be called axially projected surfaces.

The axially effective surface area A1 of the annular covering disc 16 is defined as follows:

A1=π*(r16o²−r20o²+r20i²−r16i²),

wherein

r16o=0.5*d16o,

r20o=0.5*d20o,

r20i=0.5*d20,

r16i=0.5*d16i.

The axially effective surface area A2 of the support disc 19 is defined as follows:

A2=π*(r19o²−r19i²),

wherein

r19o=0.5*d19o,

r19i=0.5*d19.

The ratio A2/A1 between an axially effective surface area A2 of the support disc 19 and an axially effective surface area A1 of the annular covering disc 16 is in a range between 0.5 and 0.9.

Preferably, the ratio A2/A1 is in a range between 0.6 and 0.8. Most preferred, the ratio A2/A1 is in a range between 0.65 and 0.75.

Such a ratio A2/A1 is preferred to maximize efficiency of the impeller 10 and to minimize noise of the impeller during operation of the same. Such a ratio A2/A1 allows a balancing of axial forces acting on the impeller 10 during operation of the same.

Preferably, the openings 20 formed within the annular covering disc 16 are conically shaped. The openings 20 formed within the annular covering disc 16 taper and thereby converge in axial direction towards the support disc 19. A conus angle of the openings 20 is in a range between 0.5° and 15°.

Preferably, the conus angle is in a range between 1.5° and 14°. Most preferred, the conus angle is in a range between 2° and 13°.

The conus angles of the openings 20 taper and thereby converge in axial direction from the front side 11 towards the rear side 12 of the impeller 10.

The conus angle αi of the openings 20 at a radial inner opening area is smaller than conus angle αo of the openings 20 at a radial outer opening area. However, both conus angles αi, αo are within the above defines ranges. Both conus angles αi, αo, with the conus angle αi being smaller than conus angle αo, are in a range between 0.5° and 15°, preferably is in a range between 1.5° and 14°, most preferred in a range between 2° and 13°.

Such conus angles are preferred to provide an impeller 10 that can be easily and reliably manufactured as one monolithic plastic piece by injection molding using a simple open-close tool. The use of such an open-close tool allows a cost-effective manufacturing of the impeller 10 by providing short manufacturing cycle times.

The impeller 10 according to the present invention is an impeller of a radial fan. Such a radial fan is part of a gas burner appliance having a boiler, a gas/air mixing device and the radial fan. The gas/air mixing device mixes gas and air thereby providing a gas/air mixture. The radial fan provides the gas/air mixture to a gas burner chamber of the boiler. The gas/air mixture becomes combusted within the gas burner chamber of the boiler. The boiler may be a condensing boiler. In such an application the impeller provides a good gas/air mixing performance with a high efficiency and low noise during operation.

### LIST OF REFERENCE SIGNS

10 impeller
11 front side
12 rear side
13 peripheral edge
14 hub element
15 blade
16 annular covering disc
16i radially inner edge
16o radially outer edge
17 intake opening
18 outflow openings
19 support disc
19i radially inner edge
19o outer edge
20 opening
20i radially inner edge
20o radially outer edge

1. An impeller for a radial fan, the impeller comprising:
a front side, a rear side and a peripheral edge;
a hub element;
an annular covering disc positioned on the front side;
an intake opening formed on the front side;
a support disc positioned on the rear side;
blades extending substantially radially from the hub element towards the peripheral edge; and
outflow openings formed in the region of the peripheral edge, wherein:
a first outer diameter of a radially outer edge of the annular covering disc is greater than a second outer diameter of a radially outer edge of the support disc
openings are formed in the annular covering disc, wherein the openings are positioned between the radially outer edge of the annular covering disc having the first outer diameter and a radially inner edge of the annular covering disc having a first inside diameter.

2. The impeller of claim 1, wherein the peripheral edge and thereby a maximum outside-diameter of the impeller is defined by the first outer diameter of the radially outer edge of the annular covering disc.

3. The impeller of claim 1, wherein the blades protrude radially outwardly from the radially outer edge of the annular covering disc so that a maximum outside-diameter of the impeller is defined by an outer diameter of the blades.

4. The impeller of claim 1, wherein the radially inner edge of the annular covering disc having the first internal diameter defines the intake opening formed on the front side.

5. The impeller of claim 1, wherein the first internal diameter of the radially inner edge of the annular covering disc is smaller than a second internal diameter of a radially inner edge of the support disc.

6. The impeller of claim 1, wherein a ratio A2/A1 between an axially effective surface area A2 of the support disc and an axially effective surface area (A1) of the annular covering disc is in a range between 0.5 and 0.9.

7. The impeller of claim 6, wherein the ratio A2/A1 is in a range between 0.6 and 0.8.

8. The impeller of claim 6, wherein the ratio A2/A1 is in a range between 0.65 and 0.75.

9. The impeller of claim 1, wherein the openings formed within the annular covering disc are defined by a radially inner edge having a third internal diameter and by a radially outer edge having a third outer diameter.

10. The impeller of claim 9, wherein:
the third internal diameter is smaller than the second internal diameter, and the third outer diameter is greater than the second internal diameter.

11. The impeller of claim 1, wherein the openings formed within the annular covering disc are conically shaped.

12. The impeller of claim 11, wherein the openings formed within the annular covering disc taper in axial direction towards the support disc.

13. The impeller of claim 11, wherein a conus angle of the openings is in a range between 0.5° and 15°.

14. The impeller of claim 13, wherein the conus angle of the openings at a radial inner opening area is smaller than the conus angle (αo) of the openings at a radial outer opening area.

15. A gas burner appliance comprising
a boiler having a gas burner chamber;
a gas/air mixing device mixing gas and air thereby providing a gas/air mixture; and
a radial fan comprising the impeller according to claim 1, the radial fan providing the gas/air mixture to the gas burner chamber of the boiler for combusting the gas/air mixture within the gas burner chamber.
